(19) United States
(12) Patent Application Publication
(10) Pub. No.: US 2025/0291165 A1
(43) Pub. Date: Sep. 18, 2025

(54) Microscope and Microscopy Method

(71) Applicant: Carl Zeiss Microscopy GmbH, Jena (DE)

(72) Inventors: Richard Hollinger, Jena (DE); Joerg Siebenmorgen, Jena (DE); Ralf Netz, Jena (DE)

(21) Appl. No.: 19/078,446

(22) Filed: Mar. 13, 2025

(30) Foreign Application Priority Data
Mar. 13, 2024 (DE) 10 2024 107 199.0

(51) Int. Cl. G02B 21/00; G02B 27/00

(52) U.S. Cl. CPC G02B 21/0032; G02B 21/0076; G02B 21/008; G02B 27/0025

(57) ABSTRACT

A microscope having a light source for transmitting excitation light, an illumination beam path with a microscope objective for guiding the excitation light onto and/or into a sample to be examined, a detector for detecting detection light emitted by the sample owing to illumination with the excitation light, a detection beam path, comprising the microscope objective or a further microscope objective, for guiding the detection light onto the detector, a first spatial light modulator arranged in or near a pupil plane of the illumination beam path, and a control unit at least for controlling the first spatial light modulator for at least partially realizing a lens function. A wavefront manipulator is arranged and/or formed in or in the vicinity of at least one intermediate image plane of the illumination beam path for compensating for distortions of the wavefront of the excitation light by the first spatial light modulator.

The current application claims the benefit of German Patent Application No. 10 2024 107 199.0, filed on 13 Mar. 2024, which is hereby incorporated by reference.

The invention relates to a microscope according to the preamble of claim 1 and a method for microscopy according to the preamble of claim 15.

A generic microscope has the following component parts: a light source for transmitting excitation light, an illumination beam path with a microscope objective for guiding the excitation light onto and/or into a sample to be examined, a detector for detecting detection light emitted by the sample owing to illumination with the excitation light, a detection beam path, comprising the microscope objective or a further microscope objective, for guiding the detection light onto the detector, a first spatial light modulator arranged in or near a pupil plane of the illumination beam path, and a control unit at least for controlling the first spatial light modulator, said control unit being configured to control the first spatial light modulator for the purpose of at least partially realizing a lens function.

In a generic method for microscopy, the following method steps are carried out: excitation light is guided onto and/or into a sample to be examined, via an illumination beam path with a microscope objective, detection light emitted by the sample owing to illumination with the excitation light is guided onto a detector via the microscope objective or a further microscope objective and is detected by said detector, the excitation light is guided via a first spatial light modulator arranged in or near a pupil plane of the illumination beam path, and the first spatial light modulator is controlled for the purpose of at least partially realizing a lens function.

A generic microscope and a generic method are known for example from DE 10 2022 103 051 A1.

It is known that a phase-modulating light modulator, for example a nematic LCOS modulator (LCOS Liquid Crystal on Silicon), arranged in a pupil plane or in the vicinity of a pupil plane of the illumination beam path can be used to generate a spatially structured illumination pattern in an intermediate image plane disposed downstream in the illumination beam path, i.e. as viewed in the direction of the sample. The pupil plane and the intermediate image plane are in this case interlinked via a lens that carries out a Fourier transformation. This lens, also referred to as a Fourier lens, is arranged between the pupil plane and the intermediate image plane and, with respect to each of these planes, is in each case at a distance corresponding to a focal length f of the lens.

By way of the phase patterns used to control the phase-modulating light modulator in the pupil plane, substantially any desired amplitude patterns can be generated in the intermediate image plane. The phase-modulating light modulator can also be referred to as phase modulator, variable phase plate, spatial light modulator or SLM. A phase pattern suitable for generating a defined amplitude pattern can be determined for example with the aid of the iterative Gerchberg-Saxton algorithm, which is also known by the designation IFTA (Iterative Fourier Transform Algorithm).

Furthermore, it is known also to generate the Fourier lens itself using the phase-modulating light modulator, [1]. The phase function ϕ_{SLM} used to control the phase-modulating light modulator is then

$${ϕ}_{SLM} = {ϕ}_{AMPL} + {ϕ}_{LENS}$$

wherein ϕ_{AMPL} denotes the phase pattern which generates the desired amplitude distribution in the intermediate image plane, and ϕ_{LENS} is the phase pattern which serves to generate the Fourier lens.

If a phase-modulating light modulator generates the Fourier lens, the real, traditional Fourier lens is no longer necessary and the distance between the pupil plane, in which the phase-modulating light modulator is arranged, and the intermediate image plane is reduced to just the focal length f_{SLM_1} of the Fourier lens generated by the phase-modulating light modulator. A more compact set-up of the optical system is also possible as a result. The Fourier lens generated by the phase-modulating light modulator can also be referred to as an SLM lens. The focal length f_{SLM_1} is generally chosen such that the illumination light or excitation light coming from the phase-modulating light modulator is suited to the subsequent optical components and the optical parameters, such as field number and aperture, for example in the intermediate image, of the microscope stand.

The following facts should be taken into consideration here: If the phase-modulating light modulator generates the Fourier lens, the product of the Fourier transform of e^{iφ}^{_{AMPL}} and a complex amplitude term with a quadratic phase in the imaginary exponent is present rather than a pure Fourier transformation of the complex light distribution of the plane in which the phase-modulating light modulator is arranged.

Specifically, the complex amplitude in the plane at a distance is given by:

$$u ( x , y , {f}_{{SLM}_{1}} ) = - i \cdot \frac{{( 2 π )}^{2}}{λ {f}_{SLM\_ 1}} \cdot {e}^{ik \cdot {f}_{SLM\_ 1}} \cdot {U}_{0} ( \frac{k}{{f}_{SLM\_ 1}} x , \frac{k}{{f}_{SLM\_ 1}} y ) \cdot {e}^{i \frac{k}{2 {f}_{SLM\_ 1}} ( {x}^{2} + {y}^{2} )}$$

In that, x and yare the coordinates in the intermediate image following the quasi-pupil SLM.

$${U}_{0} ( \frac{k}{{f}_{SLM\_ 1}} x , \frac{k}{{f}_{SLM\_ 1}} y )$$

is the Fourier transform of the light distribution directly after interaction with the phase-modulating light modulator.

For the illumination light, the presence of the quadratic phase

$${e}^{i \frac{l c}{2 {f}_{SLM\_ 1}} ( {x}^{2} + {y}^{2} )}$$

means that for example divergent beam cones emanating from non-axial illumination points have a centroid angle which is directed away from the optical axis, with the result that the ability of subsequent optical units to capture such light beams is poorer or they are possibly entirely unable to capture them any more. That means that vignetting and other field-dependent aberrations may occur and that the field of view transmitted in the direction of the sample is reduced in size.

Furthermore, the quadratic phase has the consequence that the actual pupil positions do not correspond to the expected pupil positions. Specifically, that can have the consequence that the back focal plane of the microscope objective, also referred to as objective pupil, cannot be impinged on. That is disadvantageous for applications of structured illumination microscopy (SIM) and TIRF microscopy (TIRF=Total Internal Reflection Fluorescence Microscopy), in which it is important to generate a defined light distribution in the back focal plane of the microscope objective.

An object of the invention can be considered that of specifying a microscope and a method for microscopy in which vignetting and field-dependent aberrations can be reduced or avoided.

This object is achieved by means of the microscope having the features of claim 1 and by means of the method having the features of claim 15.

According to the invention, the microscope of the type specified above is developed further in that a wavefront manipulator is arranged and/or formed in at least one intermediate image plane or in the vicinity of at least one intermediate image plane of the illumination beam path for the purpose of compensating of distortions of the wavefront of the excitation light by the first spatial light modulator.

According to the invention, the method for microscopy of the type specified above is developed further in that distortions of the wavefront that are generated by the first spatial light modulator are compensated by at least one wavefront manipulator arranged or formed in an intermediate image plane or in the vicinity of an intermediate image plane.

Preferred exemplary embodiments of the microscope according to the invention and advantageous variants of the method according to the invention are described below, in particular in association with the dependent claims and the figures.

The microscope according to the invention can advantageously be configured for carrying out the method for microscopy according to the invention, and the method for microscopy according to the invention can advantageously be carried out by the microscope according to the invention.

As a light source for the microscope according to the invention, in essence lasers are conceivable. However, other light sources are also possible. The excitation light is electromagnetic radiation preferably in the visible range and adjoining ranges. With regard to the samples to be examined, there is no restriction, in principle. The samples to be examined will often be biological samples.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also encompass dispersive and in particular diffractive elements.

Detection light is electromagnetic radiation emitted by the sample illuminated with the excitation light. The detection light can be reflected back from the sample or can be light which is transmitted through the illuminated sample. The detection light can typically be, in comparison with the excitation light, red-shifted fluorescent light from fluorescent markers used to prepare the sample. The detector can be in particular a two-dimensionally spatially resolving detector, thus a camera. Other detectors are possible, for example linear detectors for line-scanning systems and punctiform detectors for point-scanning systems. The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated obliquely, or for light sheet microscopy.

The term pupil plane denotes a plane which is perpendicular to the optical axis of the illumination beam path or of the detection beam path, and which is optically conjugate to a back focal plane of the respective microscope objective. The term intermediate image plane denotes a plane which is perpendicular to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and lenses, each have a finite extent in the direction of the optical axis.

The term wavefront manipulator denotes any optical components which change, hence manipulate, the wavefronts of the light transmitted by the relevant component or reflected at the relevant component. This manipulation can be based on diffraction and/or on refraction, for example.

The term control unit denotes all hardware and software components which interact with the components of the microscope according to the invention for the intended function thereof. In particular, the control unit can comprise a computing device, for example a PC, and a camera controller capable of rapidly reading out measurement signals. The computer resources of the control unit can be distributed among a plurality of computers and optionally a computer network, in particular also via the Internet. The control unit can have in particular customary operating devices and peripherals, such as mouse, keyboard, screen, storage media, joystick, Internet connection. The control unit can in particular read the measurement data, in particular image data, from the detector and can also be configured and serve to control the light source. According to the invention, the control unit is configured to control the first spatial light modulator for the purpose of at least partially realizing a lens function.

A basic concept of the present invention can be considered that of providing a wavefront manipulator in at least one intermediate image plane for the purpose of compensating for or correcting distortions of the wavefronts of the excitation light by the first spatial light modulator. This wavefront manipulator can be of simple nature, in principle. The terms compensating for and correcting are used synonymously in this description.

The present invention provides a microscope and a method for microscopy which are distinguished by diverse possibilities for use and various possibilities for illumination modes. This is possible with a comparatively compact optical set-up.

The first spatial light modulator can be, in principle, the sole spatial light modulator in the illumination beam path. In advantageous exemplary embodiments of the microscope according to the invention, downstream of the first spatial light modulator a second spatial light modulator is arranged in or near an intermediate image plane of the illumination beam path, and the control unit can advantageously also be configured for the purpose of controlling the second spatial light modulator, in particular for the purpose of realizing an illumination pattern for the sample. One preferred variant of the method according to the invention is accordingly distinguished by the fact that the excitation light is guided downstream of the first spatial light modulator via a second spatial light modulator arranged in or near an intermediate image plane of the illumination beam path.

In one particularly preferred configuration, the first spatial light modulator can be formed by a first sub-region of a spatial light modulator, and the second spatial light modulator can be formed by a second sub-region of the same spatial light modulator.

In principle, it is possible for at least one, a plurality or each of the components of first spatial light modulator, second spatial light modulator, spatial light modulator, to be formed by an amplitude-modulating spatial light modulator. It is advantageous, however, if at least one, a plurality or each of the components of first spatial light modulator, second spatial light modulator, spatial light modulator, is or are formed by a phase-modulating spatial light modulator. Phase-modulating spatial light modulators are preferred in general owing to the smaller light losses.

Then at least one, a plurality or each of the components of first spatial light modulator, second spatial light modulator, spatial light modulator, can be formed by a reflective spatial light modulator. However, it is also possible for at least one, a plurality or each of the components of first spatial light modulator, second spatial light modulator, spatial light modulator, to be formed by a transmissive spatial light modulator.

By way of example, at least one, a plurality or each of the components of first spatial light modulator, second spatial light modulator, spatial light modulator, can be formed by one or more of the following components: DMD (Digital Mirror Device), nematic SLM, LCOS display (LCoS=Liquid Crystal on Silicon), variable phase plate, controllable deformable mirror (DM).

The control unit can be configured to control the first spatial light modulator for the purpose of realizing an illumination pattern for the sample. If a second spatial light modulator is present, the control unit can supplementarily or alternatively be configured to control the second spatial light modulator for the purpose of realizing an illumination pattern for the sample. By way of example, a multi-spot illumination of the sample can be realized.

If beam shaping is carried out on the first spatial light modulator in the pupil plane, for example with a phase pattern, a desired intensity distribution arises on the second spatial light modulator in the intermediate image plane. Inaccuracies in the optical set-up and in the calibration of the first spatial light modulator, and/or inaccuracies, in particular discretization errors, when generating and representing a pattern used to control the first spatial light modulator can have the effect that a portion of the excitation light coming from the first spatial light modulator is incident on the second spatial light modulator outside an intended region.

A basic concept of advantageous developments of the invention can now be considered that of combating such inaccuracies by virtue of a grating being represented by means of the second spatial light modulator in the regions outside an intended illumination region, the period of which grating is chosen such that the light diffracted at this grating cannot be propagated as far as the sample by the further illumination beam path.

As a result, the accuracy of the illumination patterns can be increased. In particular, it is possible to attain a lower intensity background in the sample for many illumination modes.

Specifically, in one particularly preferred exemplary embodiment of the microscope according to the invention, the control unit can be configured to control the second spatial light modulator outside a desired illumination region for the purpose of representing a grating, the period of which is chosen such that excitation light of the +1st and/or of the −1st order of diffraction lies in at least one pupil plane outside a region through which there is propagation as far as the sample.

Accordingly, one preferred variant of the method according to the invention is distinguished by the fact that the second spatial light modulator is controlled outside a desired illumination region for the purpose of representing a grating, the period of which is chosen such that light of the +1st and/or of the −1st order of diffraction lies in at least one pupil plane outside a region through which there is propagation as far as the sample.

An axial spatial direction and two lateral spatial directions can be given by an optical axis of the illumination beam path, and the distortions of the wavefront that are to be compensated for can be quadratic phase terms of the excitation light in coordinates of the lateral spatial directions in particular.

In preferred configurations of the method according to the invention and of the microscope according to the invention, a plurality of wavefront manipulators cooperate in the compensating step. These different wavefront manipulators can be arranged or formed in different intermediate image planes or in the vicinity of different intermediate image planes. However, it is also possible for a plurality of wavefront manipulators to be arranged or formed in one intermediate image plane or in the vicinity of one and the same intermediate image plane.

The vignetting explained above that is caused by the use of the first spatial light modulator in the manner described can be at least partially reduced in configurations of the microscope according to the invention in which at least one wavefront manipulator realizes a positive focal length. By way of example, the disadvantages mentioned can be avoided by inserting a field lens into an intermediate image plane or into the vicinity of an intermediate image plane.

In comparatively simple solutions for compensating for the distortions of the wavefronts of the excitation light that are caused by the first spatial light modulator, in particular the quadratic phase of the excitation light in the lateral coordinates, the wavefront manipulator has a glass lens having a positive focal length or the wavefront manipulator is realized by a glass lens having a positive focal length. The lens, in particular the glass lens, provides a positive correction field lens which provides an inverse quadratic phase with respect to the quadratic phase left over from the first spatial light modulator.

For the case of the intermediate image plane in the illumination beam path downstream of the phase modulator, this field lens then makes possible once again the concept of the imaging of exit pupils of upstream optical units onto entrance pupils of downstream optical units. Field of view vignetting, edge light falloff and generally aberrations of the optical system can be reduced as a result.

In one simple configuration of the method, the compensating step is partially or completely provided by a glass lens as wavefront manipulator. By way of example, a traditional positive glass lens can be arranged in an intermediate image plane or in the vicinity of an intermediate image plane in the illumination beam path. Since an individual field lens having a typical focal length of 200 mm, for example, has a relatively great influence on the wavefront of the excitation light, permanent positioning of this positive glass lens in the illumination beam path is disadvantageous since specific illumination modes may no longer be possible. In particular, illumination modes requiring collimated light in the intermediate image, for example TIRF (Total Internal Reflection Fluorescence) or SIM (Structured Illumination Microscopy), would not be possible, which would be detrimental to a multimodal illumination concept. TIRF and SIM can be realized for example with a spatial light modulator arranged in an intermediate image plane or in the vicinity of an intermediate image plane in the illumination beam path. In preferred exemplary embodiments of the microscope according to the invention, therefore, a changer device is present for the purpose of inserting the glass lens into the illumination beam path or removing it therefrom.

The changer device can have a plurality of glass lenses of varying focal length and one of the glass lenses can in each case be inserted into the intermediate image plane or in the vicinity of the intermediate image plane by the changer device. The control device can expediently be configured for controlling the changer device. The changer device is preferably configured such that the glass lens can be removed from the illumination beam path or be moved into the latter in a motorized manner.

A further advantageous embodiment of the microscope according to the invention is distinguished by the fact that the wavefront manipulator has an adjustable lens or is realized by an adjustable lens. The compensating step can be partially or completely provided by an adjustable lens as wavefront manipulator. With the aim of a multimodal illumination concept in which, in particular, as just described, illumination modes requiring collimated light in the intermediate image are also possible, it is additionally advantageous if the adjustable lens is adjustable to a neutral position. Expediently, the control device can be configured for controlling the adjustable lens.

The adjustable lens can advantageously also be used and configured to adapt different pupil positions of different microscope objectives.

A further advantageous embodiment of the microscope according to the invention is distinguished by the fact that the wavefront manipulator alternatively or supplementarily has a Fresnel lens or is realized by a Fresnel lens. The compensating step can be partially or completely provided by controlling the second spatial light modulator for the purpose of generating a Fresnel lens having a positive focal length. Alternatively or supplementarily, the first spatial light modulator and/or the second spatial light modulator can be controlled for the purpose of adapting different pupil positions of different microscope objectives for the purpose of realizing a Fresnel lens.

The control device can preferably be configured to control the second spatial light modulator in such a way that quadratic phase terms of the excitation light in coordinates of the lateral spatial directions are partially or completely compensated for by the second spatial light modulator. By way of example, the second spatial light modulator can be controlled for the purpose of at least partially realizing a Fresnel lens.

The first spatial light modulator and/or the second spatial light modulator can be controlled for the purpose of generating different illumination patterns for the sample.

Further advantages and features of the present invention are explained below in association with the figures, in which:

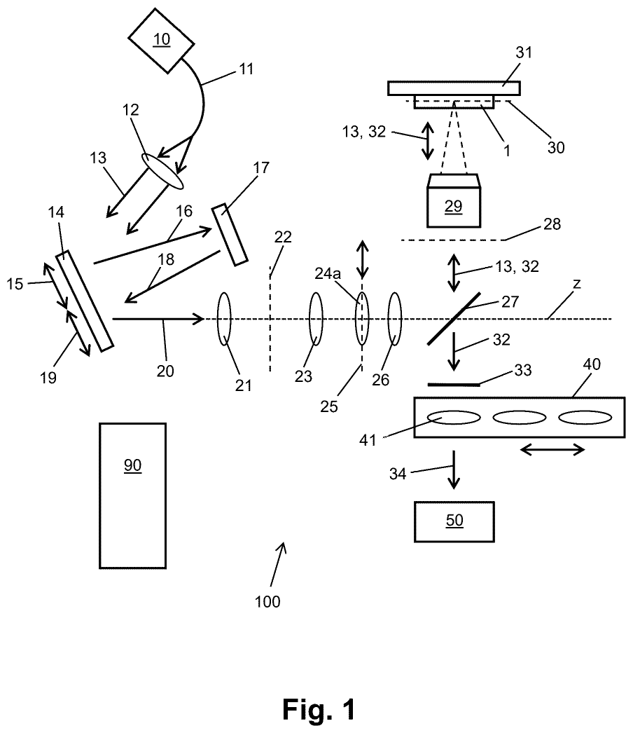

FIG. 1: shows a first exemplary embodiment of a microscope according to the invention; and

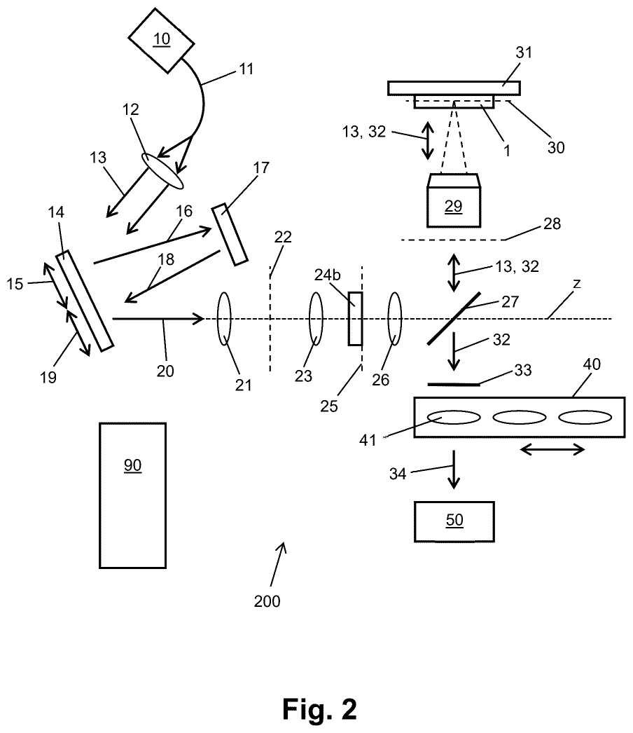

FIG. 2: shows a second exemplary embodiment of a microscope according to the invention.

Identical and identically acting component parts are generally provided with the same reference signs in the figures.

A first exemplary embodiment of the microscope according to the invention will be explained with reference to FIG. 1. The microscope 100 according to the invention as shown schematically in FIG. 1 has firstly a light source 10 for transmitting excitation light 13 and an illumination beam path with a microscope objective 29 for guiding the excitation light onto a sample 1 to be examined. A detector 50 is then present for the purpose of detecting detection light 32 emitted by the sample 1 owing to the illumination with the excitation light 13. A detection beam path, comprising the microscope objective 29 in the exemplary embodiment shown, is present for the purpose of guiding the detection light 32 onto the detector 50. It would also be possible, for example in a transmitted-light arrangement, for the detection beam path to have a dedicated microscope objective. According to the invention, a first spatial light modulator 15 is present in the illumination beam path, said modulator being arranged in or near a pupil plane of the illumination beam path. In the exemplary embodiments in the figures, moreover, downstream of the first spatial light modulator 15 a second spatial light modulator 19 is present, which is arranged in or near an intermediate image plane of the illumination beam path.

In the exemplary embodiments shown in the figures, the first spatial light modulator 15 is formed by a first sub-region of a spatial light modulator 14, and the second spatial light modulator 19 is formed by a second sub-region of the same spatial light modulator 14. The light modulator 14 can be for example an SLM from HOLOEYE Photonics AG, DE.

Furthermore, a control unit 90 is present, which serves at least for controlling the first spatial light modulator 15 and, in the exemplary embodiments in the figures, also the second spatial light modulator 19 and, according to the invention, is configured to control the first spatial light modulator 15 in such a way that the first spatial light modulator 15 at least partially realizes a lens function for the excitation light.

The control unit 90 in the exemplary embodiment shown is then configured to control the first spatial light modulator 15 and/or the second spatial light modulator 19 in such a way that a desired illumination pattern is realized in an intermediate image plane and in particular in the sample 1. By way of example, the sample 1 can be impinged on by a multi-spot illumination.

Finally, in the example of a microscope 100 according to the invention as shown in FIG. 1, a wavefront manipulator formed by a glass lens 24a is present in an intermediate image plane 25 and, according to the invention, serves to compensate for or to correct distortions of the wavefront of the excitation light that are generated by the first spatial light modulator 15.

In specific detail, the excitation light 13 from the light source 10, for example a laser, passes via an optical fibre 11 and a lens 12, which serves for collimating the beam, to the phase modulator 14. Specifically, the excitation light 13 is incident on the first spatial light modulator 15, which is arranged in a pupil plane or in the vicinity of a pupil plane of the illumination beam path and which is controlled by the control unit 90 for the purpose of realizing a lens function or parts of a lens function. In the exemplary embodiment shown in FIG. 1, pupil planes are such planes which are optically conjugate to a back focal plane 28 of the microscope objective 29.

The excitation light 16 manipulated in this way is then incident on a mirror 17 arranged at such a distance from the phase modulator 14 that the second sub-region 19, hence the second spatial light modulator 19, is situated in an intermediate image plane or in any case in the vicinity of an intermediate image plane of the illumination beam path. In the exemplary embodiment shown in FIG. 1, intermediate image planes are such planes which are optically conjugate to a focal plane 30 of the microscope objective 29. Since the focal plane lies within the sample 1 in the example shown, it can also be referred to as sample plane or object plane.

Light reflected by the second spatial light modulator 19 passes via a relay optical unit, which is formed by lenses 21 and 23, to the glass lens 24a in the intermediate image plane 25. Between the lenses 21 and 23, a pupil plane 22 is formed, in which optionally for example a further spatial light modulator, in particular a phase modulator, can be arranged (not illustrated in FIG. 1). A changer device is indicated by a double-headed arrow at the glass lens 24a, and enables the glass lens 24a to be removed from the beam path or replaced by a different glass lens, not illustrated in FIG. 1.

After the excitation light 13 has passed through a tube lens 26 downstream of the intermediate image plane 25, the excitation light 13 is incident on a main beam splitter 27 and is guided by the latter in the direction of the microscope objective 29. Finally, the microscope objective 29 guides the excitation light 13 into the sample plane 30 of the sample 1, which is mounted on a sample holder 31 shown schematically. By way of example, the excitation light 13 is focused into the sample plane 30 of the sample 1.

Owing to the sample 1 being illuminated with the excitation light 13, the sample 1 emits detection light 32, which can be in particular fluorescent light which is red-shifted in comparison with the excitation light 13. Via the microscope objective 29, the detection light 32 passes back to the main beam splitter 27, is transmitted by the latter, is subsequently filtered by an emission filter 33 and is then imaged onto the detector 50 as filtered emission light 34 by a tube lens 41. The detector 50 can be a camera, for example. Detection light 34 detected by the camera 50 can be evaluated by the control unit 90. For the purpose of adapting to different microscope objectives and/or for the purpose of realizing different image sizes on the camera 50, a tube lens changer 40 is provided in the example shown, which serves to introduce different tube lenses into the detection beam path.

What is essential to the present invention is the glass lens 24a arranged in the intermediate image plane 25 and having a positive focal length, which realizes a wavefront manipulator and which, according to the invention, serves to compensate for or to correct distortions of the wavefront of the excitation light that are introduced by the first sub-region of the phase modulator 14, hence the first spatial light modulator 15.

The distortions of the wavefront that are to be compensated for are in particular quadratic phase terms of the excitation light 13 in coordinates of lateral spatial directions x, y. Here the lateral spatial directions x, y are given by the two spatial directions that are perpendicular to one another and in each case to an axial spatial direction, the axial spatial direction being given by an optical axis z of the illumination beam path.

In the first exemplary embodiment explained in association with FIG. 1, the compensation of the distortions of the wavefront that are introduced by the control of the first spatial light modulator 15 to form a lens function can in principle be completely effected by the glass lens 24a as wavefront manipulator.

Alternatively, it is also possible for the compensation of the distortions of the wavefront that are generated by the first spatial light modulator 15 to be completely provided by control of the second spatial light modulator 19 for the purpose of generating a Fresnel lens having a positive focal length. The glass lens 24a can then be removed from the illumination beam path by the changer device. The control device 90 is then configured to control the second spatial light modulator 19 in such a way that quadratic phase terms of the excitation light 13 in coordinates of the lateral spatial directions are completely compensated for by the second spatial light modulator 19.

It should be taken into consideration here that the pixels of the phase modulator 14, for example the pixels of an SLM, each allow only a maximum phase deviation, i.e. that the phase dynamic range is less than or equal to 2TT. That means that for quadratic phase values to be corrected which are greater than 2TT, the phase value must in each case be mapped into the phase dynamic range of the relevant pixel that is specifically possible for the phase modulator 14 used. That means that integral multiples of 2TT are subtracted in each case. This method is known by the term “phase wrapping” and can be described mathematically by the modulo function:

ϕ_{WRAPPED}=ϕ_{mod(2π)}

In that, ϕ_{WRAPPED} is the phase value with which the phase modulator 14 is to be controlled and ϕ_{mod(2π)} is the value of the quadratic phase to be corrected minus integral multiples of 2π. The quadratic phase to be corrected is also referred to as a quadratic field lens phase. Towards the edge of the intermediate image, ϕ_{mod(2π)} may rise rapidly, with the result that numerous phase jumps have to be introduced under certain circumstances, in a manner similar to that for a Fresnel lens or a zone plate. That can have the consequence that a field lens realized by the second spatial light modulator 19, i.e. by the second sub-region 19 of the phase modulator 14 in the example, which field lens is also referred to as an SLM field lens, is less effective towards the edge of the field. That can mean for example that the reduction of field vignetting diminishes towards the edge.

The possibilities for using the second spatial light modulator 19 to manipulate the excitation light 13, for example for the purpose of generating illumination patterns for the sample 1, are thus restricted if the second spatial light modulator 19 is also used for compensating for the distortions introduced by the first spatial light modulator 15. In a simplifying manner of expression, phase adjustment power of the second spatial light modulator 19 is consumed by the generation of the Fresnel lens.

Preferably, however, the second spatial light modulator 19 can also be controlled in such a way as to realize there indeed a Fresnel lens and hence a further wavefront manipulator, which cooperates with a glass lens in the intermediate image plane for the purpose of compensating for the distortions introduced by the first spatial light modulator 15. That is to say that a glass lens then remains in the illumination beam path. The control device 90 is then configured to control the second spatial light modulator 19 in such a way that quadratic phase terms of the excitation light 13 in coordinates of the lateral spatial directions are only partially compensated for by the second spatial light modulator 19. In this variant, the compensation is thus provided by the functionality of the correction field lens being distributed as it were between two intermediate image planes, namely the plane in which the second spatial light modulator 19 is arranged and the intermediate image plane 25. By way of example, it is possible firstly to generate a first, weaker, Fresnel field lens in the second spatial light modulator 19. That is preferably done without phase jumps in the edge region of the second spatial light modulator 19. As glass lens in the intermediate image plane 25, what is then enough is a glass lens having a lower refractive power than that of the glass lens 24a, which is sufficient to accomplish the compensation alone. Both field lenses, namely the field lens provided by the second spatial light modulator 19 and the glass lens in the intermediate image plane 25, then jointly produce the compensation function which is necessary according to the invention and which, in the variants described above, is provided either only by the glass lens 24a or only by the field lens of the second spatial light modulator 19.

A second exemplary embodiment of a microscope 200 according to the invention is shown in FIG. 2. The sole difference when comparing the microscope 200 with the microscope 100 in FIG. 1 is that in the intermediate image plane 25, instead of the glass lens 24a having a positive focal length, an adjustable lens 24b having a positive focal length is provided as a wavefront manipulator. The adjustable lens 24b, which can be for example an adaptive lens from Optotune Switzerland AG, CH, DYNAMIC OPTICS srl, IT, or Phaseform GmbH, DE, can expediently be controlled by the control unit 90.

The adjustable lens 24b having a positive focal length once again makes it possible to compensate for the quadratic phase, if necessary. Preferably, the adjustable lens 24b additionally makes possible a neutral position, in which there is substantially no influence on the excitation light 13, with the result that, as described above, illumination modes such as TIRF and SIM requiring a collimated beam path in the intermediate image plane 25 can also be realized.

As in the exemplary embodiment in FIG. 1, in the exemplary embodiment in FIG. 2 as well, the compensation of the distortions of the wavefront that are generated by the first spatial light modulator 15 can be completely provided by control of the second spatial light modulator 19 for the purpose of generating a Fresnel lens having a positive focal length. The glass lens 24b can then be set to its neutral position.

Furthermore, in the exemplary embodiment in FIG. 2 as well, as described above with regard to the exemplary embodiment in FIG. 1, the second spatial light modulator 19 can be controlled for the purpose of realizing a Fresnel lens which as first wavefront manipulator cooperates with the adjustable lens 24b as second wavefront manipulator for the purpose of compensating for the distortions introduced by the first spatial light modulator 15. In comparison with that situation in which the compensation is effected by the adjustable lens 24b alone, the adjustable lens 24b then only has to be adjusted to a lower refractive power. In the case of the second spatial light modulator 19, advantageously, less phase adjustment power is then consumed for providing a Fresnel lens.

The use of the adjustable lens 24b has the advantage that fewer mechanically movable components are required, and that given suitable dimensioning no phase adjustment power is consumed for generating a Fresnel lens in the case of the second spatial light modulator 19. What may be considered to be possible disadvantages of adjustable lenses are the ageing properties thereof, the comparatively high costs, and the slight scattering of illumination light from excitation light at control electrodes in the optical window. For example, the TIRF mode would be disadvantageously influenced by this scattering.

One advantage of the combination of a Fresnel lens provided by the second spatial light modulator 19 with the adjustable lens 24b is that only a lower refractive power is required for the adjustable lens 24b, and that this can thus be realizable mechanically more simply and can be more cost-effective.

If both field lenses are switched off, i.e. if the second spatial light modulator 19 and the adjustable lens 24b are each set to neutral, the illumination light 13 is no longer influenced by a lens effect and other illumination modes, for example TIRF and/or SIM, can be implemented.

If no field lens is required in the intermediate image plane 25 in one of the illumination modes, the glass lens 24a has to be removed from the illumination beam path in the case of the exemplary embodiment in FIG. 1, and the adjustable lens 24b has to be set to its neutral position in the exemplary embodiment in FIG. 2. The glass lens 24a could remain in the illumination beam path and the adjustable lens 24b could remain in a setting with a finite refractive power only if the influence of these components on the respective illumination mode is small or can be disregarded.

Alternatively, it would also be possible to leave the glass lens 24a (FIG. 1) in the illumination beam path and to leave the adjustable lens 24b (FIG. 2) in a control state of finite refractive power and additionally to control the second spatial light modulator 19 for the purpose of realizing a negative Fresnel lens in such a way that the effect of the glass lens 24a (FIG. 1) and respectively of the adjustable lens 24b (FIG. 2) is compensated for.

Different microscope objectives generally also have different pupil positions. In order to correct these offsets of the pupil positions when the microscope objective is changed, use is often made of a movable optics group, for example a movable collimator. The solution proposed here, which is essentially based on compensating for the quadratic phase by means of a field lens, in particular a variable field lens, can also be used to carry out the necessary correction of the pupil positions. By way of example, the adjustable lens 24b can preferably also be used and can be configured to adapt different pupil positions of different microscope objectives.

Likewise, the first spatial light modulator 15 and/or the second spatial light modulator 19 in both exemplary embodiments can be controlled for the purpose of adapting different pupil positions of different microscope objectives for the purpose of realizing a Fresnel lens. In the case of the first spatial light modulator 15, that may only be possible with limitations in the optical quality.

The present invention provides a flexible multimodal illumination system that is based on the application of spatial light modulators and has improved properties with regard to its optical performance, without the multimodality incurring losses in the process.

### LIST OF REFERENCE SIGNS

1 sample
10 light source, laser
11 optical fibre
12 lens
13 excitation light
14 phase modulator=phase mask, SLM
15 first spatial light modulator, first half of phase modulator 14, pupil plane
16 excitation light 13 radiated from phase modulator 14 in the direction of mirror 17
17 mirror
18 excitation light 13 reflected by mirror 17
19 second spatial light modulator 19, second half of phase modulator 14, intermediate image plane
20 excitation light 13 emitted from phase modulator 14 to the microscope
21 lens
22 pupil plane
23 lens, forms relay optical unit with lens 21
24a glass lens, introducible into and withdrawable from the beam path
24b adjustable lens, adaptive lens
25 intermediate image plane
26 tube lens
27 main beam splitter
28 back focal plane of microscope objective 29
29 microscope objective
30 sample plane, object plane, focal plane of microscope objective 29
31 sample holder
32 light emitted, here reflected back, from sample 1
33 emission filter
34 emission light, filtered by emission filter 33
40 tube lens changer in the detection beam path
41 tube lens
50 camera
90 control unit (PC)
100 exemplary embodiment of a microscope according to the invention
200 exemplary embodiment of a microscope according to the invention

### REFERENCES

[1] Paolo Pozzi et al.: High-throughput spatial light modulation two-photon microscopy for fast functional imaging, Pozzi; in Neurophotonics Vol. 2, page 015005-1 (2015)
[2] Reto Fiolka: Clearer view for TIRF and oblique illumination; in Optics Express Vol. 24, page (2016)
[3] Reto Fiolka, Markus Beck, and Andreas Stemmer: Structured illumination in total internal reflection fluorescence microscopy using a spatial light modulator; in Optics Letters Vol. 33, page 1629 (2008)
[4] Shao L.; Kner P.; Hesper E.; Gustafsson Mats G. L: Super-resolution 3D-microscopy of live whole cells using structured illumination; in Nature Methods, Vol. 8 (2011)

1. Microscope comprising:
a light source for transmitting excitation light,
an illumination beam path with a microscope objective for guiding the excitation light onto and/or into a sample to be examined,
a detector for detecting detection light emitted by the sample owing to illumination with the excitation light,
a detection beam path, comprising the microscope objective or a further microscope objective, for guiding the detection light onto the detector,
a first spatial light modulator arranged in or near a pupil plane of the illumination beam path, and
a control unit at least for controlling the first spatial light modulator, said control unit being configured to control the first spatial light modulator for at least partially realizing a lens function,
wherein a wavefront manipulator is arranged and/or formed in at least one intermediate image plane or in the vicinity of at least one intermediate image plane of the illumination beam path for compensating distortions of the wavefront of the excitation light by the first spatial light modulator.

2. Microscope according to claim 1,
wherein downstream of the first spatial light modulator a second spatial light modulator is arranged in or near an intermediate image plane of the illumination beam path, and
wherein the control unit is also configured for controlling the second spatial light modulator.

3. Microscope according to claim 2,
wherein the control unit is configured to control the second spatial light modulator outside a desired illumination region for representing a grating, the period of which is chosen such that excitation light of the +1st and/or of the −1st order of diffraction lies in at least one pupil plane outside a region through which there is propagation as far as the sample.

4. Microscope according to claim 1,
wherein an axial spatial direction and two lateral spatial directions are given by an optical axis of the illumination beam path, and
wherein the distortions of the wavefront that are to be compensated for are quadratic phase terms of the excitation light in coordinates of the lateral spatial directions.

5. Microscope according to claim 1,
wherein at least one wavefront manipulator realizes a positive focal length.

6. Microscope according to claim 1,
wherein the wavefront manipulator has a glass lens having a positive focal length or is realized by a glass lens having a positive focal length.

7. Microscope according to claim 6,
wherein a changer device is present for inserting the glass lens into the illumination beam path or removing it therefrom.

8. Microscope according to claim 7,
wherein the changer device has a plurality of glass lenses of varying focal length, and
wherein one of the glass lenses is in each case insertable into the intermediate image plane or in the vicinity of the intermediate image plane by the changer device.

9. Microscope according to claim 1,
wherein the wavefront manipulator has an adjustable lens or is realized by an adjustable lens.

10. Microscope according to claim 9,
wherein the adjustable lens is adjustable to a neutral position.

11. Microscope according to claim 1,
wherein the wavefront manipulator has a Fresnel lens or is realized by a Fresnel lens.

12. Microscope according to claim 2,
wherein the control device is configured to control the second spatial light modulator for at least partially realizing a Fresnel lens.

13. Microscope according to claim 2,
wherein the control device is configured to control the second spatial light modulator in such a way that quadratic phase terms of the excitation light in coordinates of the lateral spatial directions are partially or completely compensated by the second spatial light modulator.

14. Microscope according to claim 2,
wherein the first spatial light modulator is formed by a first sub-region of a spatial light modulator, and wherein the second spatial light modulator is formed by a second sub-region of the same spatial light modulator.

15. Method for microscopy, comprising:
guiding excitation light onto and/or into a sample to be examined, via an illumination beam path with a microscope objective, guiding detection light emitted by the sample owing to illumination with the excitation light is guided onto a detector via the microscope objective or a further microscope objective, detecting the detection light by said detector,
the excitation light is guided via a first spatial light modulator arranged in or near a pupil plane of the illumination beam path, and
the first spatial light modulator is controlled for at least partially realizing a lens function,
wherein distortions of the wavefront that are generated by the first spatial light modulator are compensated by at least one wavefront manipulator arranged or formed in an intermediate image plane or in the vicinity of an intermediate image plane.

16. Method according to claim 15,
wherein the excitation light is guided downstream of the first spatial light modulator via a second spatial light modulator arranged in or near an intermediate image plane of the illumination beam path.

17. Method according to claim 16,
wherein the second spatial light modulator is controlled outside a desired illumination region for representing a grating, the period of which is chosen such that light of the +1st and/or of the −1st order of diffraction lies in at least one pupil plane outside a region through which there is propagation as far as the sample.

18. Method according to claim 15,
wherein a plurality of wavefront manipulators cooperate in the compensating step.

19. Method according to claim 18,
wherein the wavefront manipulators are each arranged or formed in different intermediate image planes or in the vicinity of different intermediate image planes.

20. Method according to claim 15,
wherein the compensating step is partially or completely provided by at least one of a glass lens or an adjustable lens, as a wavefront manipulator.

21. (canceled)

22. Method according to claim 20,
wherein the adjustable lens is used to adapt different pupil positions of different microscope objectives.

23. Method according to claim 15,
wherein the compensating step is partially or completely provided by controlling the second spatial light modulator for of generating a Fresnel lens having a positive focal length.

24. Method according to claim 15,
wherein for adapting different pupil positions of different microscope objectives, the first spatial light modulator and/or the second spatial light modulator are/is controlled for realizing a Fresnel lens.

25. Method according to claim 15,
wherein the first spatial light modulator and/or the second spatial light modulator are/is controlled for generating an illumination pattern for the sample.
